(19) United States
(12) Patent Application Publication
(10) Pub. No.: US 2021/0169041 A1
(43) Pub. Date: Jun. 10, 2021

(54) Pet Food Processing Machine

(71) Applicant: Michael Directo, Palm Springs, CA (US)

(72) Inventor: Michael Directo, Palm Springs, CA (US)

(21) Appl. No.: 17/112,851

(22) Filed: Dec. 4, 2020

Related U.S. Application Data
(60) Provisional application No. 62/944,624, filed on Dec. 6, 2019.

(51) Int. Cl. A01K 5/00; A23K 40/30; A23K 50/48; A23K 10/20; A23B 4/07; A23L 3/365; A23K 30/00; A01K 5/01

(52) U.S. Cl. CPC A01K 5/004; A23K 40/30; A23K 50/48; A23K 10/20; A23V 2002/00; A23L 3/365; A23K 30/00; A01K 5/0128; A23B 4/07

(57) ABSTRACT

An encapsulated food processing machine receives packages of frozen or freeze-dried food encapsulated in edible film. The machine heats water, pumps it to the portion of the machine with the encapsulated food, and mixes the encapsulated food while heating it with the warm water. The result is a ready-to-eat meal. In use, a user determines a number of packages of encapsulated food based on a pet's size and weight, and places the packages into a specially designed bowl. The user selects the number and type of packages on the machine, which prepares the food via the aforementioned process. The bowl with the ready-to-eat meal is then removed from the machine, and the pet eats the meal directly from the bowl.

### RELATED APPLICATION

This application claims priority to U.S. Provisional Patent Application Ser. No. 62/944,624 for a “Pet Food Processing Machine,” filed Dec. 6, 2019, and currently co-pending, the entirety of which is incorporated herein by this reference.

### FIELD OF THE INVENTION

The present invention pertains generally to food processing and preparation. More particularly, the present invention pertains to a process and apparatus for use in preparing food. The Present invention is particularly, but not exclusively, useful as a tool and corresponding process for preparing pet food.

### BACKGROUND OF THE INVENTION

Pet food varies with the type of animal kept as a pet. Dogs and cats, which are among the most common pets kept in the United States, are generally fed kibble, often referred to as “dry food,” or canned “wet food.” As interest in more natural food options increases among the general population, pet owners are also taking an interest in better food options for their pets. Both healthier and fresher pet food options are becoming important to consumers, and, as a result, stores are offering refrigerated and frozen options in addition to the traditional canned wet food and bagged kibble.

Frozen food provides fresher, and often more nutritious, meals for pets, but comes with its own disadvantages, including the need for thawing the food. Common methods of thawing frozen pet food include thawing it in water, thawing it on a counter, and thawing it in a refrigerator. Each of these methods often require a number of hours to thaw the food. Due to the time required, pet owners will often thaw several days' worth of food at a time, and store the thawed food in a refrigerator. Unfortunately, even when refrigerated, thawed food only lasts for a few days.

In light of the above, it would be advantageous to provide a natural pet food option with natural vitamins and minerals, fresh taste, and a mechanism for automated preparation.

### SUMMARY OF THE INVENTION

Disclosed is a pod machine for processing encapsulated food. A pod machine provides easy meal preparation by mixing and preparing packages of encapsulated food. A preferred embodiment is particularly useful for mixing and preparing packages of encapsulated pet food for consumption by a pet.

In a preferred embodiment, pet food is prepared without the use of synthetic vitamins and minerals. Feed testing is used for each formulation in order to ensure that it meets the minimum nutrient levels set by the Association of American Feed Control Officials (“AAFCO”) for nutrient profiles for “all life stages.” The food is prepared according to the specifications of its corresponding formulation and is pressed through a dye to form small meat shapes. After pressing, one embodiment of the food is flash frozen. Another embodiment is freeze dried. Both embodiments are then placed in pod encapsulating machines in which the food is sandwiched between two pieces of non-polyvinyl alcohol (non-PVA) film and made into sheets for encapsulating. Preferred embodiments of the non-PVA film include film made out of agar agar, film made out of gelatin, and film made out of starch. A predetermined amount of food is encapsulated in each package or “pod.” In the case of flash-frozen food, the pods are frozen, packed, and packaged ready to ship to the consumer. For freeze dried foods, the food is freeze dried, chopped, and mixed with freeze dried vegetables and additives, packed and packaged into pods ready to ship to the consumer.

A preferred embodiment of a pod processing machine includes a removable stainless-steel bowl. In order to prepare the pods for consumption by a pet, a pet owner adds pods, still in the non-PVA film, to the bowl. The number of pods added to the bowl is based on the size and weight of the animal to be fed. The type of food (frozen or freeze dried) is selected on the machine, the number of pods is selected, and a start button is pressed. The machine then draws water from a reservoir and heats a predetermined amount of water by pumping it through a heater and a thermometer. The machine ultimately transfers the heated water to the bowl containing the pods. The food is then mixed in the bowl by a mixing paddle designed to dice up the meat in the pod into smaller pieces, allowing it to thaw more quickly in the warm water.

An alternative embodiment provides food pods made of food fit for human consumption encapsulated in edible film. The food is prepared according to the specifications of its corresponding formulation, including, in some embodiments, additives such as vitamins and minerals, and is pressed through a dye to form small food shapes. For some foods, the pressing step is omitted. After pressing, one embodiment of the food is flash frozen. Another embodiment is freeze dried. Both embodiments are then placed in pod encapsulating machines in which the food is sandwiched between two pieces of non-polyvinyl alcohol (non-PVA) film and made into sheets for encapsulating. Preferred embodiments of the non-PVA film include film made out of agar agar, film made out of gelatin, and film made out of starch. A predetermined amount of food is encapsulated in each package or “pod.”

In the alternative embodiment, a meal is prepared by determining a combination of one or more pods, adding pods into a bowl or mixing chamber in a food processing machine similar to that described above or in other embodiments herein, and operating the machine to mix the pods in heated water. In order to prepare more intricate meals, some combinations of pods will include pods inserted into the machine at different portions of the preparation process. For example, an exemplary pasta meal includes pods with pressed food for sauce and meat, and an unpressed pasta pod; the food and meat pods are inserted into the food processing machine at the beginning of the process, and the pasta pod is added after the food and meat pods are diced and mixed in heated water. It will be apparent to one of ordinary skill in the art that the machine and food preparation process are useful and appropriate to a variety of foods, and especially useful for pastas, soups, stews, and casseroles, among other foods.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 illustrates a process for creating food pods;

FIG. 2 illustrates a processing machine for preparing food pods for consumption;

FIG. 3 illustrates a mixing sequence performed by a processing machine;

FIG. 4 illustrates another mixing sequence performed by a processing machine;

FIG. 5 is a top perspective view of a preferred embodiment of a processing machine for preparing food pods for consumption;

FIG. 6 is a front view of the processing machine of FIG. 5;

FIG. 7 is a left side view of the processing machine of FIG. 5;

FIG. 8 is a right side view of the processing machine of FIG. 5;

FIG. 9 is a rear view of the processing machine of FIG. 5;

FIG. 10 is a top view of the processing machine of FIG. 5;

FIG. 11 illustrates a preferred embodiment of a control panel for a processing machine for preparing food pods for consumption; and

FIG. 12 illustrates components of a preferred embodiment of a processing machine for preparing food pods for consumption.

### DETAILED DESCRIPTION

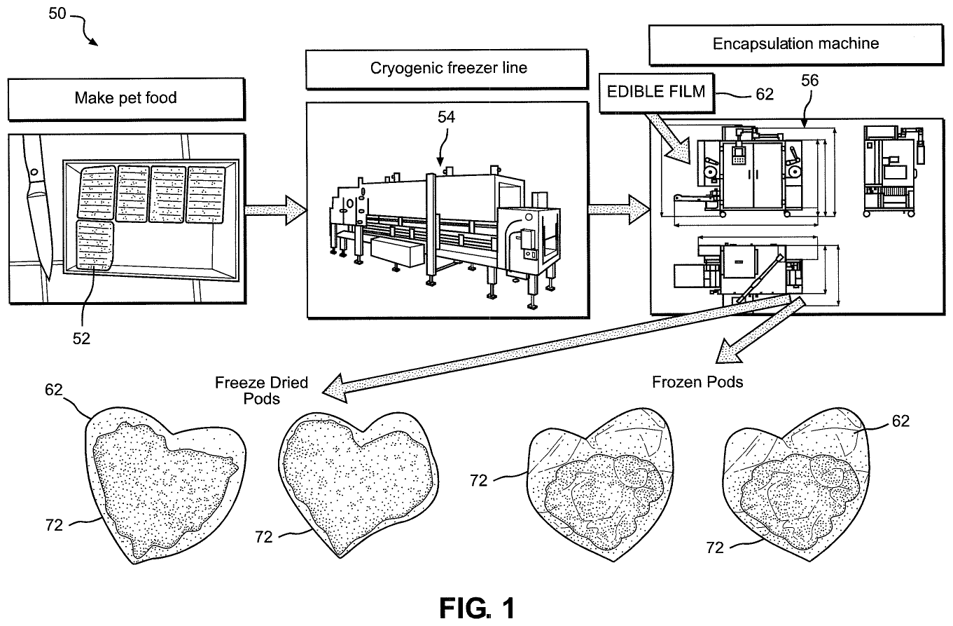

Referring initially to FIG. 1, a process for creating food pods is illustrated and generally designated 50. In process 50, pet food is prepared according to a predetermined formulation and pressed in a dye to form compressed pet food 52. The compressed food is flash frozen 54 and then transferred to an encapsulation machine 56 where it is sandwiched between two pieces of edible film 62 and formed into capsules or pods 72 of compressed frozen food encapsulated in the edible film 62. An alternative embodiment of process 50 is substantially similar, except that the compressed food is freeze dried rather than flash frozen.

A preferred embodiment of the compressed pet food 52 is made without the use of synthetic vitamins and minerals. Preferred embodiments of the edible film 62 are non-PVA film; among the embodiments of non-PVA film is film made out of agar agar, film made out of gelatin, and film made out of starch. The agar agar, gelatin, starch, or other edible material is formed into sheets for encapsulating.

A preferred embodiment of the edible film 62 is made with an agar agar base made into sheets for encapsulating. Variations of this embodiment have added vitamins and minerals to meet the AAFCO minimum pet nutritional requirements, and include the various combinations of one or more of zinc proteinate, manganese proteinate, sodium selenite, niacin supplement, d-calcium pantothenate, riboflavin supplement, vitamin A supplement, vitamin D3 supplement, vitamin B12 supplement, pyridoxine hydrochloride, and folic acid. A preferred embodiment is simply made of the base without added vitamins or minerals because the food that it will encapsulate already contains the necessary vitamins and minerals required by regulations or other relevant guidelines.

An alternative preferred embodiment of the edible film 62 is made with a starch base made into sheets for encapsulating. Variations of this embodiment have added vitamins and minerals to meet the AAFCO minimum pet nutritional requirements, and include the various combinations of one or more of zinc proteinate, manganese proteinate, sodium selenite, niacin supplement, d-calcium pantothenate, riboflavin supplement, vitamin A supplement, vitamin D3 supplement, vitamin B12 supplement, pyridoxine hydrochloride, and folic acid. A preferred embodiment is simply made of the base without added vitamins or minerals because the food that it will encapsulate already contains the necessary vitamins and minerals required by regulations or other relevant guidelines.

Another alternative preferred embodiment of the edible film 62 is made with a combination of starch and agar agar made into sheets for encapsulating. Variations of this embodiment have added vitamins and minerals to meet the AAFCO minimum pet nutritional requirements, and include the various combinations of one or more of zinc proteinate, manganese proteinate, sodium selenite, niacin supplement, d-calcium pantothenate, riboflavin supplement, vitamin A supplement, vitamin D3 supplement, vitamin B12 supplement, pyridoxine hydrochloride, and folic acid. A preferred embodiment is simply made of the base without added vitamins or minerals because the food that it will encapsulate already contains the necessary vitamins and minerals required by regulations or other relevant guidelines.

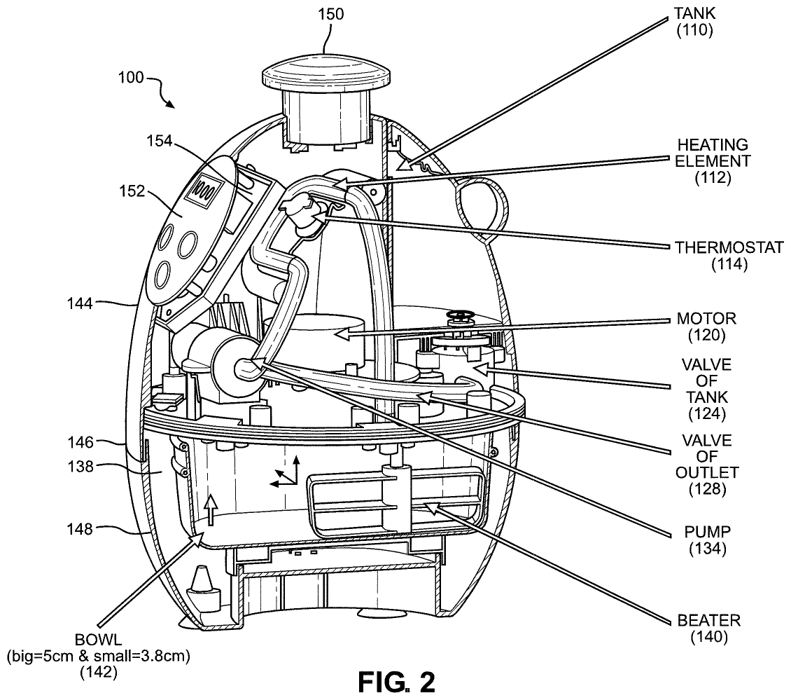

Referring now to FIG. 2, a pod 72 processing machine 100 is illustrated. Pod processing machine 100 has a water tank 110, a heating element 112, a thermostat 114, a motor 120, a tank valve 124, an outlet valve 128, a pump 134, a mixing chamber 138, and a mixing paddle 140. Machine 100 also has a removeable stainless-steel bowl 142 configured for placement in chamber 138 and operational with the machine 100. A preferred embodiment of bowl 142 is adjustable between two size depths in order to accommodate the different types of pet snouts.

To use machine 100, the machine 100 is opened to allow access to bowl 142 for the placement of food pods 72 (not shown in this figure). The number of food pods 72 is determined based on an animal's size and weight. The food pods 72 are placed into bowl 142, and the machine 100 is closed. A preferred embodiment of machine 100 is roughly egg-shaped, and opened by engaging a button 150 at the top of the machine 100, which allows the top part 144 of the machine 100 to be separated at seam 146 from the bottom portion 148 containing chamber 138 and bowl 142, exposing bowl 142 in order to allow the insertion of pods 72. After placement of pods 72 and closing of the machine 100, the number of pods 72 and whether they are freeze-dried or frozen is selected using control panel 152 on the machine 100 that interfaces with a controller 154 having a central processor, program memory, and control outputs. In response to the data entered through the control panel 152 as input to the central processor, the mixing process is initiated. Based upon the user input and operational criteria within the program memory, the machine 100 draws a quantity of water, determined by the type of food, from tank 110. Pump 134 moves the water through heating element 112 and thermostat 114 in order to heat it to a predetermined temperature, and then transfers the water to bowl 142 via a drip system, where paddle 140 dices and mixes the food from pods 72. Motor 120 operates pump 134 and paddle 140. Upon completion of the mixing process, the bowl 142 is removed from the food processing machine 100 and the mixed food is fed to a pet directly from bowl 142. The bowl 142 is then cleaned and replaced into food processing machine 100 for additional use; in preferred embodiments, bowl 142 is secured into chamber 138 of machine 100 with a screwing motion, and made removable by a corresponding reverse motion.

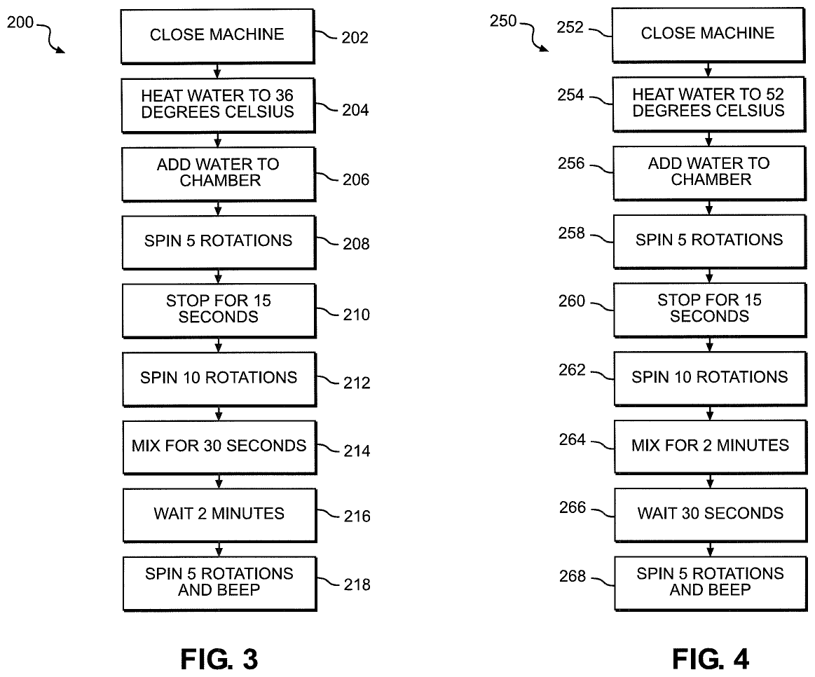

Referring now to FIG. 3, a preferred embodiment of a process performed by machine 100 for preparing a pet meal from pods 72 is illustrated and generally designated 200. Process 200 is particularly useful for the preparation of meals from freeze dried pods 72. In order to initiate process 200, a user places one or more food pods 72 into bowl 142, selects the number of pods 72 and the type of pods 72 on control panel 152 on the machine 100, and presses a button to start the process 200.

Process 200 begins with step 202 of closing the machine 100 or otherwise locking bowl 142 into place so that it cannot be removed until the food is ready. In step 204, water from tank 110 is heated to twenty-six (26) degrees Celsius. In step 206, the heated water is added to the chamber 138, or, more particularly, bowl 142. In preferred embodiments, the water is added by a drip system to bowl 142. In step 208 paddle 140 is spun for five (5) rotations at a first predetermined speed, then in step 210 the spinning is stopped for fifteen (15) seconds. In step 212, the spinning is resumed for ten (10) rotations at a second predetermined speed. In step 214, the food is mixed for thirty (30) seconds by spinning mixing paddle 140 at a third predetermined speed. After mixing the food, in step 216 the food is allowed to sit for two (2) minutes, after which step 218 is performed. Step 218 includes spinning paddle 140 for five (5) additional rotations at a fourth predetermined speed followed by the control panel 152 emitting a signal that the food is ready. Preferred embodiments of machine 100 emit the signal as a beep, or an illumination signal, or a combination of both. The identification of four predetermined speeds is not intended to mean that in every embodiment each predetermined speed is different from any or all of the other predetermined speeds. In one embodiment, the third predetermined speed is a “medium speed,” meaning that at least one other predetermined speed is a higher speed, and at least one other predetermined speed is a lower speed.

Referring now to FIG. 4, another preferred embodiment of a process performed by machine 100 for preparing a pet meal from pods 72 is illustrated and generally designated 250. Process 250 is particularly useful for the preparation of meals from frozen pods 72. As with process 200, in order to initiate process 250, a user places one or more food pods 72 into bowl 142, selects the number of pods 72 and the type of pods 72 on control panel 152 on the machine 100, and presses a button to start the process 250.

Process 250 begins with step 252 of closing the machine 100 or otherwise locking bowl 142 into place so that it cannot be removed until the food is ready. In step 254, water from tank 110 is heated to fifty-two (52) degrees Celsius. In step 256, the heated water is added to the chamber 138, or, more particularly, bowl 142. In preferred embodiments, the water is added by a drip system to bowl 142. In step 258 paddle 140 is spun for five (5) rotations at a first predetermined speed, then in step 260 the spinning is stopped for fifteen (15) seconds. In step 262, the spinning is resumed for ten (10) rotations at a second predetermined speed. In step 264, the food is mixed for two (2) minutes by spinning mixing paddle 140 at a third predetermined speed. After mixing the food, in step 266 the food is allowed to sit for thirty (30) seconds, after which step 268 is performed. Step 268 includes spinning paddle 140 for five (5) additional rotations at a fourth predetermined speed, followed by the control panel 152 emitting a signal that the food is ready. Preferred embodiments of machine 100 emit the signal as a beep, or an illumination signal, or a combination of both. The identification of four predetermined speeds is not intended to mean that in every embodiment each predetermined speed is different from any or all of the other predetermined speeds. In one embodiment, the third predetermined speed is a “medium speed,” meaning that at least one other predetermined speed is a higher speed, and at least one other predetermined speed is a lower speed.

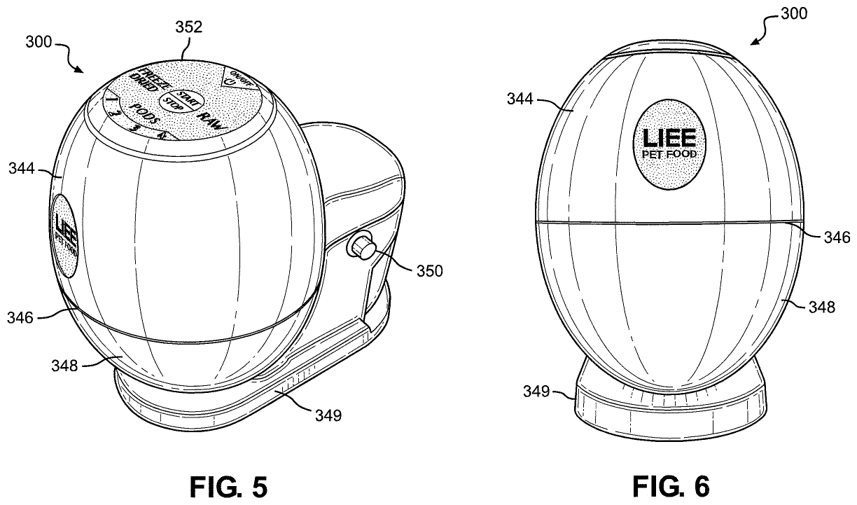

Referring now to FIG. 5, a top perspective view of a preferred embodiment of a pod processing machine 300 is illustrated. Pod processing machine 300 includes a top part 344 separable at seam 346 from bottom portion 348 through engagement of button 350 on the side of machine 300. In a preferred embodiment, bottom portion 348 sits on top of a base 349 supporting machine 300.

Referring now to FIG. 6, a front view of pod processing machine 300 is illustrated, showing top part 344 and bottom part 348 separated at seam 346.

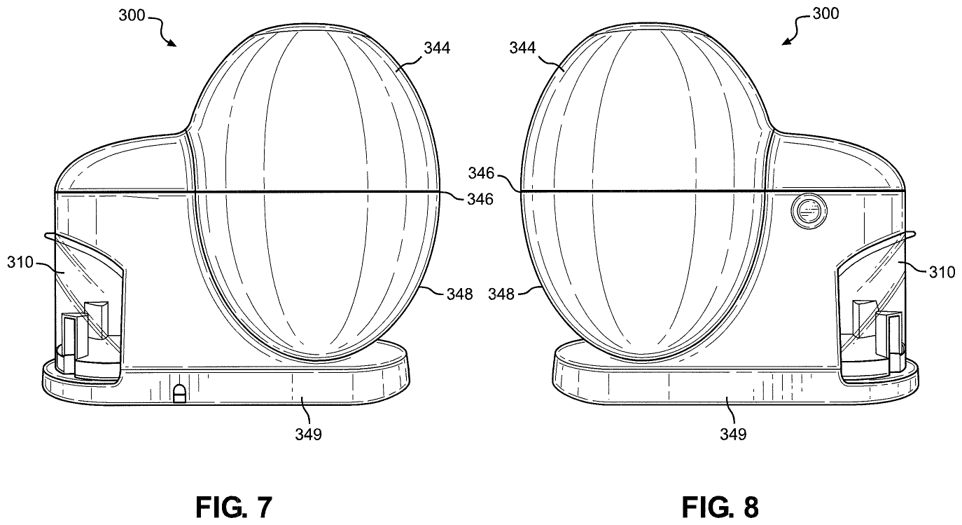

Referring now to FIG. 7, a left side view of pod processing machine 300 is illustrated, showing water tank 310.

Referring now to FIG. 8, a right side view of pod processing machine 300 is illustrated, showing water tank 310 and button 350.

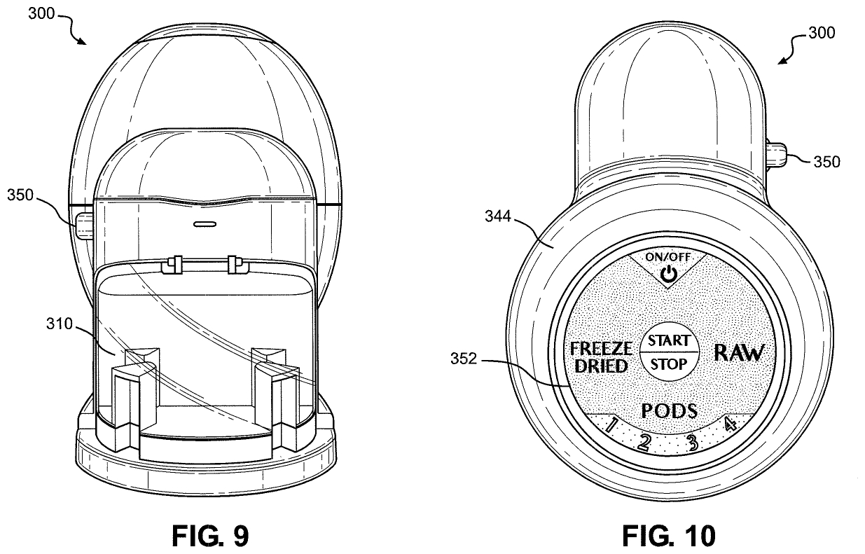

Referring now to FIG. 9, a rear view of pod processing machine 300 is illustrated, showing water tank 310.

Referring now to FIG. 10, a top view of pod processing machine 300 is illustrated, showing button 350 and control panel 352.

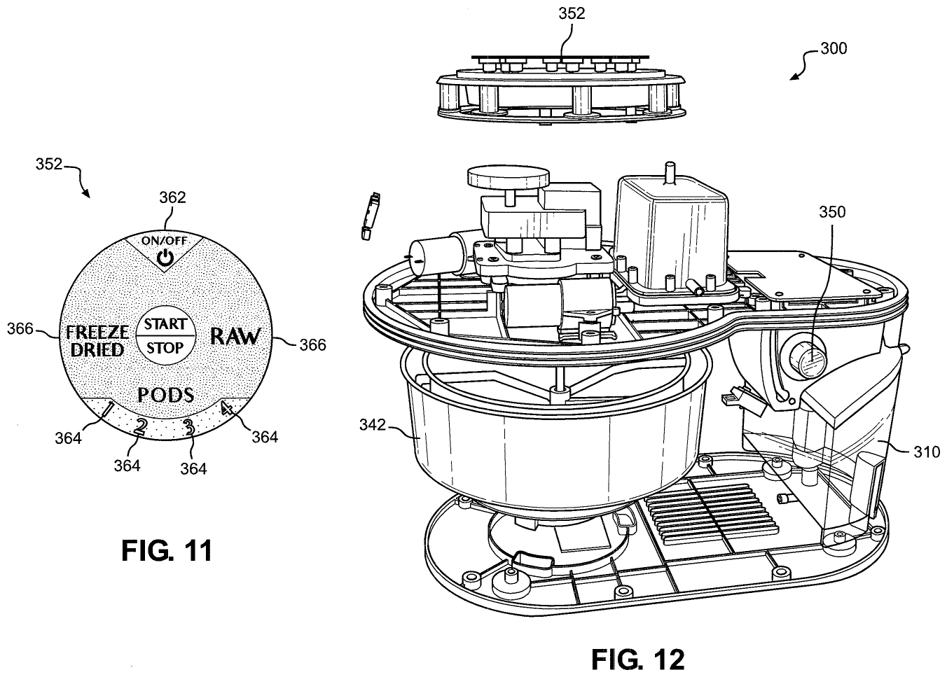

Referring now to FIG. 11, control panel 352 is illustrated, showing the various selectable options. A preferred embodiment of a control panel 352 includes engageable user interface elements such as buttons for operating a pod processing machine 300. Exemplary elements include an on/off button 362 for turning on or off machine 300, buttons 364 engageable to select the number of pods in bowl 342 (shown in FIG. 12), buttons 366 to select whether freeze-dried or frozen pods 72 (see FIG. 1) are being used, and a start/stop button 368 to initiate preparation of the food.

Referring now to FIG. 12, an exploded view of pod processing machine 300 is illustrated, showing several of its components. Structurally, machine 300 is similar to machine 100, having the same components described with respect to machine 100; the components, however, are arranged and laid out appropriate to the overall shape and design of machine 300.

Functionally, machine 300 operates in a similar manner to machine 100. Machine 300 has and is operable with bowls 342 of different sizes to accommodate the different types of pet snouts. To use machine 300, the machine 300 is opened to allow access to bowl 342 for the placement of food pods 72 (not shown in FIG. 12). The number of food pods 72 is determined based on an animal's size and weight. The food pods 72 are placed into bowl 342 (selected from the available bowls 342 as appropriate for the animal to be fed), which in turn is placed in the chamber of bottom portion 348, and the machine 300 is closed. The number of pods and whether they are freeze-dried or frozen is selected using control panel 352 on the machine 300 that interfaces with a controller having a central processor, program memory, and control outputs. In response to the data entered through the control panel 352 as input to the central processor, the mixing process is initiated. Based upon the user input and operational criteria within the program memory, the machine 300 draws a quantity of water, determined by the number of pods 72, from tank 310. The pump moves the water through the heating element and thermostat in order to heat it to a predetermined temperature, and then transfers the water to bowl 342 via a drip system, where the paddle dices and mixes the food from pods 72. Upon completion of the mixing process, the bowl 342 is removed from the food processing machine 300 and the mixed food is fed to a pet directly from bowl 342. The bowl 342 is then cleaned and replaced into food processing machine 300 for additional use; in preferred embodiments, bowl 342 is secured into the chamber of bottom portion 348 of machine 300 with a screwing motion, and made removable by a corresponding motion in reverse.

Some embodiments of machine 300 intended for use with food for human consumption process the food with additional steps in the preparation processes described in FIGS. 3 and 4, which vary depending upon the combination of food pods selected. Such embodiments of machine 300 include an alternative embodiment of control panel 352 suitable for selecting the combination of pods in order to instruct the machine to carry out the appropriate steps. Such steps include unlocking the bottom portion during parts of the process in order to add additional pods that do not require all the processing steps, mixing steps with an alternative paddle that doesn't dice the food, as well as other steps appropriate to a particular meal.

Embodiments of a pod processing machine with the various possible combinations of features of the pod processing machines described herein are also fully contemplated.

While there have been shown what are presently considered to be preferred embodiments of the present invention, it will be apparent to those skilled in the art that various changes and modifications can be made herein without departing from the scope and spirit of the invention.

I claim:

1. A food processor, comprising:
an encapsulated food processing machine, comprising:
a bowl,
a paddle,
a pump,
a heating element,
a thermostat, and
a control panel,
wherein the encapsulated food processing machine is configured to receive pods comprising encapsulated food in the bowl, and
wherein the encapsulated food processing machine is configured to heat water, transfer the heated water to the bowl, and operate the paddle to dice and mix food from the pods.

2. The food processor as recited in claim 1, wherein the encapsulated food processing machine further comprises a bottom portion configured to removably receive the bowl, allowing processed food to be served to an animal directly from the bowl.

3. The food processor as recited in claim 1, wherein the encapsulated food processing machine further comprises a water tank.

4. The food processor as recited in claim 3, wherein the pump is configured to obtain the water from the water tank.

5. The food processor as recited in claim 4, wherein the heating element, and thermostat are configured to heat the water.

6. The food processor as recited in claim 5, wherein the heated water is transferred to the bowl via a drip system.

7. The food processor as recited in claim 1, wherein the pods comprise flash-frozen or freeze-dried food encapsulated in an edible film.

8. The food processor as recited in claim 7, wherein the edible film is a non-polyvinyl-alcohol (non-PVA) film.

9. The food processor as recited in claim 8, wherein the edible film is made out of agar agar, gelatin, or starch.

10. A process for preparing a pet meal, comprising the steps of:
providing an encapsulated food processing machine, comprising:
a bowl,
a paddle,
a pump,
a heating element,
a thermostat, and
a control panel;
providing one or more pods comprising encapsulated food;
placing the one or more pods into the bowl;
closing the machine;
heating water to twenty-six degrees Celsius;
adding the water to the bowl;
spinning the paddle for five rotations at a first predetermined speed;
waiting fifteen seconds;
spinning the paddle for ten rotations at a second predetermined speed;
spinning the paddle for thirty seconds at a third predetermined speed;
waiting two minutes;
spinning the paddle for five rotations at a fourth determined speed; and
emitting a signal.

11. The process for preparing a pet meal of claim 10, wherein the signal is a beep.

12. The process for preparing a pet meal of claim 10, wherein the third predetermined speed is a medium speed.

13. The process for preparing a pet meal of claim 10, wherein the one or more pods comprise encapsulated freeze-dried food.

14. The process for preparing a pet meal of claim 13, wherein the freeze-dried food is encapsulated in an edible non-polyvinyl-alcohol (non-PVA) film.

15. The process for preparing a pet meal of claim 14, wherein the edible non-PVA film is made out of agar agar, gelatin, or starch.

16. A process for preparing a pet meal, comprising the steps of:
providing an encapsulated food processing machine, comprising:
a bowl,
a paddle,
a pump,
a heating element,
a thermostat, and
a control panel;
providing one or more pods comprising encapsulated food;
placing the one or more pods into the bowl;
closing the machine;
heating water to fifty-two degrees Celsius;
adding the water to the bowl;
spinning the paddle for five rotations at a first predetermined speed;
waiting fifteen seconds;
spinning the paddle for ten rotations at a second predetermined speed;
spinning the paddle for two minutes at a third predetermined speed;
waiting thirty seconds;
spinning the paddle for five rotations at a fourth determined speed; and
emitting a signal.

17. The process for preparing a pet meal of claim 16, wherein the signal is a beep.

18. The process for preparing a pet meal of claim 16, wherein the one or more pods comprise encapsulated freeze-dried food.

19. The process for preparing a pet meal of claim 18, wherein the freeze-dried food is encapsulated in an edible non-polyvinyl-alcohol (non-PVA) film.

20. The process for preparing a pet meal of claim 19, wherein the edible non-PVA film is made out of agar agar, gelatin, or starch.
